(19) United States
(12) Patent Application Publication
(10) Pub. No.: US 2025/0355692 A1
(43) Pub. Date: Nov. 20, 2025

(54) Master time translation in peripheral device

(71) Applicant: MELLANOX TECHNOLOGIES, LTD., Yokneam (IL)

(72) Inventors: Wojciech Wasko, Mlynek (PL); Stephen Glaser, San Francisco, CA (US); Jonathon Evans, Santa Clara, CA (US); Vikramjit Sethi, Austin, TX (US); Nir Laufer, Zoran (IL); Dotan David Levi, Kiryat Motzkin (IL)

(21) Appl. No.: 18/664,354

(22) Filed: May 15, 2024

(51) Int. Cl. G06F 9/455; G06F 13/42

(52) U.S. Cl. CPC G06F 9/45558; G06F 13/4221; G06F 2009/45579; G06F 2213/0026

(57) ABSTRACT

In one embodiment, a system includes a peripheral device, which includes an interface to receive from a virtual machine (VM) running on a host device, over a communication data bus, a request for timing data derived from a time measurement dialogue, the host device maintaining a master clock time, a hardware clock to maintain a peripheral device clock time, and processing circuitry to transform the master clock time to a frame of reference of the VM, and provide to the VM, over the communication data bus, the timing data based on the peripheral device clock time, and the master clock time transformed to the frame of reference of the VM.

### FIELD OF THE DISCLOSURE

The present disclosure relates to computer systems, and in particular, but not exclusively to, clock measurement.

### BACKGROUND

Peripheral Component Interconnect Express (PCIe) Precision Time Measurement PTM is used as a time offset measurement technology within systems (e.g., between a peripheral device and a root port, e.g., of a host device connected to the peripheral device), replacing legacy, jittery methods to measure time offset between different devices in the system. PCIe PTM is an optional feature within the PCIe specification that provides a common “PTM Master Time”. The PTM Master Time serves like a common ruler, allowing different devices in a PCIe system to measure the offset of their local time with respect to the PTM Master Time. The PTM Master Time is disseminated from the PTM Root which is typically implemented inside the PCIe Root Port.

The PTM measurement is basically a simultaneous snapshot of the PTM Master Time and the peripheral device's local time/counter value. The PTM measurement is obtained by the peripheral device exchanging some PCIe messages with its upstream link partner (e.g., a PTM Request from the peripheral device towards the link partner and a PTM Response/ResponseD from the link partner towards the peripheral device). Once the data is available, an equation specified in the PCIe base specification can be applied to calculate a pair of two simultaneous snapshots of the device's clock and the PTM Master Time. The peripheral device either provides raw data or the results of the equation to software which can then discipline a clock, or clocks as needed.

There is often a known, fixed relation between the PTM Master Time and a counter that is used to construct central processor unit (CPU) and/or software clocks (e.g., a Time Stamp Counter (TSC) in x86 architectures or CNTPCT_EL0 (System Counter) in ARM architectures). An oscillator provides a frequency source for the PTM Master Time. The oscillator may also provide the frequency source for the CPU counter. The CPU counter may also start at boot but may run at its own frequency (e.g., at a multiple or fraction of the oscillator frequency). Thus, the fixed relation may be used by the CPU to translate the measurements from “(PTM Master Time value; device time value)” to “(CPU counter value; device time value)”.

### SUMMARY

There is provided in accordance with an embodiment of the present disclosure, a system, including a peripheral device, which includes an interface to receive from a virtual machine (VM) running on a host device, over a communication data bus, a request for timing data derived from a time measurement dialogue, the host device maintaining a master clock time, a hardware clock to maintain a peripheral device clock time, and processing circuitry to transform the master clock time to a frame of reference of the VM, and provide to the VM, over the communication data bus, the timing data based on the peripheral device clock time, and the master clock time transformed to the frame of reference of the VM.

Further in accordance with an embodiment of the present disclosure the processing circuitry is to retrieve the peripheral device clock time at time t, compute the master clock time at time t, transform the master clock time at time t to the frame of reference of the VM, and provide to the VM, over the communication data bus, the timing data including a simultaneous snapshot of the master clock time at time t transformed to the frame of reference of the VM and the peripheral device clock time at time t.

Still further in accordance with an embodiment of the present disclosure the processing circuitry is to transform the master clock time to the frame of reference of the VM based on a transformation between the master clock time and a virtual counter value of the VM.

Additionally in accordance with an embodiment of the present disclosure the processing circuitry is to transform the master clock time to the frame of reference of the VM based on a transformation between the master clock time and a virtual counter value of the VM, the system further including the host device including a master clock to maintain the master clock time, a CPU counter, wherein a value of the CPU counter has a given relationship with the master clock time, a central processing unit (CPU) to run a hypervisor to manage the VM, provide the virtual counter value of the VM to the VM upon request of the VM based on a given relationship between the value of the CPU counter and the virtual counter value, wherein the transformation between the master clock time and the virtual counter value of the VM is based on (a) the given relationship between the value of the CPU counter and the master clock time, and (b) the given relationship between the value of the CPU counter and the virtual counter value.

Moreover in accordance with an embodiment of the present disclosure the hypervisor is to instruct the peripheral device to apply the transformation between the master clock time and the virtual counter value of the VM when providing the master clock time to the VM.

Further in accordance with an embodiment of the present disclosure the processing circuitry is to run a virtual function of the peripheral device to transform the master clock time to the frame of reference of the VM based on the transformation between the master clock time and the virtual counter value of the VM.

Still further in accordance with an embodiment of the present disclosure the hypervisor is to configure the virtual function to apply the transformation between the master clock time and the virtual counter value of the VM when providing the master clock time to the VM.

Additionally in accordance with an embodiment of the present disclosure the peripheral device includes a network device, and the virtual function of the peripheral device is a virtual network adapter of the VM.

Moreover in accordance with an embodiment of the present disclosure the host device includes a root port, which includes the master clock.

Further in accordance with an embodiment of the present disclosure the host device includes an oscillator to provide an output signal for use by the master clock and the CPU counter.

Still further in accordance with an embodiment of the present disclosure the processing circuitry is to run a virtual function of the peripheral device to transform the master clock time to the frame of reference of the VM based on a transformation between the master clock time and a virtual counter value of the VM.

Additionally in accordance with an embodiment of the present disclosure the peripheral device includes a network device, and the virtual function of the peripheral device is a virtual network adapter of the VM.

Moreover in accordance with an embodiment of the present disclosure the peripheral device includes a graphic processing unit (GPU), and the virtual function of the peripheral device is a virtual GPU of the VM.

Further in accordance with an embodiment of the present disclosure the master clock of the host device is included in a root port of the host.

Still further in accordance with an embodiment of the present disclosure the processing circuitry is to compute the master clock time Precision Time Measurement (PTM) based on measurement messages exchanged by any two or more of the following the host device, the peripheral device, and a switch device disposed in the communication data bus between the host device and the peripheral device.

There is also provided in accordance with another embodiment of the present disclosure, a method, including receiving from a virtual machine (VM) running on a host device, over a communication data bus, a request for timing data derived from a time measurement dialogue, maintaining a peripheral device clock time, transforming a master clock time to a frame of reference of the VM, and providing to the VM, over the communication data bus, the timing data based on the peripheral device clock time, and the master clock time transformed to the frame of reference of the VM.

Additionally in accordance with an embodiment of the present disclosure, the method includes retrieving the peripheral device clock time at time t, and computing the master clock time at time t, wherein the transforming includes transforming the master clock time at time t to the frame of reference of the VM, and the providing includes providing to the VM, over the communication data bus, the timing data including a simultaneous snapshot of the master clock time at time t transformed to the frame of reference of the VM and the peripheral device clock time at time t.

Moreover in accordance with an embodiment of the present disclosure the transforming includes transforming the master clock time to the frame of reference of the VM based on a transformation between the master clock time and a virtual counter value of the VM.

Further in accordance with an embodiment of the present disclosure the transforming includes transforming the master clock time to the frame of reference of the VM based on a transformation between the master clock time and a virtual counter value of the VM, the method further including providing the virtual counter value of the VM to the VM upon request of the VM based on a given relationship between the value of the CPU counter and the virtual counter value, wherein the transformation between the master clock time and the virtual counter value of the VM is based on (a) the given relationship between the value of a CPU counter and the master clock time, and (b) the given relationship between the value of the CPU counter and the virtual counter value.

Still further in accordance with an embodiment of the present disclosure, the method includes instructing the peripheral device by a hypervisor to apply the transformation between the master clock time and the virtual counter value of the VM when providing the master clock time to the VM.

Additionally in accordance with an embodiment of the present disclosure the transforming is performed by a virtual function of a peripheral device.

Moreover in accordance with an embodiment of the present disclosure, the method includes configuring the virtual function to apply the transformation.

Further in accordance with an embodiment of the present disclosure, the method includes computing the master clock time Precision Time Measurement (PTM) based on measurement messages exchanged by any two or more of the following the host device, a peripheral device, and a switch device disposed in the communication data bus between the host device and the peripheral device.

### BRIEF DESCRIPTION OF THE DRAWINGS

The present disclosure will be understood from the following detailed description, taken in conjunction with the drawings in which:

FIG. 1 is a block diagram view a clock measurement system constructed and operative in accordance with an embodiment of the present disclosure;

FIG. 2 is a data flow diagram showing example time measurement dialogues in the system of FIG. 1;

FIG. 3 is a flowchart including steps in a method performed by a CPU of a host device in the system of FIG. 1;

FIG. 4 is a flowchart including steps in a method performed by a virtual machine in the system of FIG. 1; and

FIG. 5 is a flowchart including steps in a method performed by a peripheral device in the system of FIG. 1.

### DESCRIPTION OF EXAMPLE EMBODIMENTS

### Overview

As previously mentioned, Peripheral Component Interconnect Express (PCIe) Precision Time Measurement PTM is used as a time offset measurement technology within systems (e.g., between a peripheral device and a root port, e.g., of a host device connected to the peripheral device), replacing legacy, jittery methods to measure time offset between different devices in the system. However, naïve application of PCIe PTM in virtualized environments leaks information about the underlying HW platform to unprivileged software (such as virtual machines) which can have unintended consequences.

Some problems with PTM & virtualization are now described.

First, a virtual machine does not know the relationship between PTM Master Time and virtual machine (VM) time (e.g., VM CPU counter value) due to the CPU counter either being entirely virtualized (i.e., when the VM reads the register that it believes to contain the CPU counter value, this read is trapped and emulated with the response (counter value) produced by Hypervisor software), and/or due to use of CPU counter scaling/offset functionality (i.e., when the VM reads the register containing the CPU counter value, the response comes from the physical CPU counter but before the value is returned, it is offset and scaled by the CPU hardware according to parameters pre-programmed in the CPU hardware by the Hypervisor software).

CPU counter value emulation of scaling and/or offset is performed to “hide” from the unprivileged agents (e.g. Virtual Machines) the information about the physical system that the VMs are running on. For example, a virtual machine can be migrated between different physical machines. If the CPU counter value exposed to the virtual machine is the raw physical counter value of the CPU counter, the virtual machine could observe discontinuities and glitches in the values reported to the virtual machine as the virtual machine is being migrated, and thereby infer information from the values that the VM should not have access to or suffer a malfunction as many applications assume that there are no discontinuities of time and will behave incorrectly if time jumps, especially backwards. To prevent discontinuities from occurring, when a VM is migrated from one physical system to another, hypervisor software of the target system typically configures TSC virtualization appropriately so that when the VM is restarted, the TSC appears contiguous to the VM.

As previously mentioned, the PTM Master Time and TSC can derive from the same oscillation source. In bare-metal hardware, the relation between PTM Master Time and the TSC counter can be established because the TSC frequency and/or phase difference is known. However, for Virtual Machines the TSC scaling & offset are not known to the VMs; instead, they're controlled by the Hypervisor.

Second, when the peripheral device attached to the Virtual Machine reports PCIe PTM measurements, it exposes the value of the PTM Master Time, which is a physical counter, thus exposing information about the underlying physical system. This can be used to detect whether a Virtual Machine was suspended or migrated (it would appear as one or more discontinuities in PTM Master Time values over time).

Single root I/O virtualization (SR-IOV) is a PCIe device virtualization standard. It allows a single physical PCIe device to be shared directly among multiple virtual machines (VMs) without the need for hypervisor intervention in the data path. A hypervisor is a privileged software running unvirtualized on the host CPU. The hypervisor manages the physical resources and VMs. In the context of SR-IOV, the hypervisor sets up and allocates Virtual Functions (VFs) for VMs, establishing the mapping between VFs and VMs.

A physical Function (PF) represents the main functionality of the PCIe device and acts as a manager for the SR-IOV capability, enabling and controlling the VFs. A Virtual Function (VF) is a lightweight PCIe function created by the PF and provides the input/output (I/O) resources and interfaces that VMs can directly use, essentially giving VMs “direct” access to parts of the physical PCIe device. VMs do not directly interact with the PF, instead, they interface with VFs. Each VM typically has its own unique VF, allowing direct, efficient, and isolated access to the resources of the PCIe device.

In an SR-IOV enabled setup, the hypervisor's main task is the initial configuration and allocation of VFs to VMs. Once allocated, the VMs interact with these VFs as if the VFs were dedicated hardware devices, enhancing performance by bypassing the traditional virtualization data path that involves the hypervisor.

As mentioned above, in virtualized systems, when a VM requests its virtual counter value, the CPU counter value is scaled and/or offset by the CPU to provide the virtual counter value. Due to the VM not knowing the transformation between the CPU counter and its virtual counter, the VM does not know the relationship between its time and the PTM master time. If the VM were to ask the peripheral device to supply the latest PTM dialogues between peripheral device and PCIe root port, for example, the peripheral device would provide the raw PTM master time timestamp. First, providing the raw PTM master time timestamp may be viewed as a security breach, but it also makes PTM unusable, as even if the PTM dialogues were supplied to the VM, the VM could not do anything with the dialogues as the VM does not know the translation parameters between PTM master and its own time.

For example, the CPU could request the latest PTM dialogues from the peripheral device. The peripheral device would return the peripheral device time at time t, and the corresponding PTM master time at time t. As the CPU (or hypervisor) knows the relationship between the PTM master time and its own time, the CPU (or hypervisor) can use the received values, e.g., to synchronize between the CPU clock and the peripheral device clock. The VM, on the other hand, cannot do this as the VM does not know its relationship with the PTM master time.

Embodiments of the present disclosure address at least some of the above drawbacks by providing a device in which the CPU (e.g., by the hypervisor running on the CPU) provides the translation parameters (e.g., constant offset addition and/or multiplication by a value) between the PTM master time and the virtual counter value of a VM to the peripheral device so that the peripheral device may translate any PTM master time value to the frame of reference of the VM using the translation parameters. The peripheral device may then provide the PTM master time value(s) in the frame of reference of the VM to the VM.

In some embodiments, the hypervisor provides the translation parameters to a virtual function (VF) of the VM so that the VF may translate any PTM master time value to the frame of reference of the VM using the translation parameters. The VF may then provide the PTM master time value(s) in the frame of reference of the VM to the VM. In some embodiments, when the hypervisor instantiates the VF for the VM, the hypervisor may configure the VF to apply the transformation between the PTM master time and the VM counter value to any PTM master time value.

In some embodiments, the transformation is programmable, i.e. the peripheral device may expose configuration parameters which define the transformation to be applied to the data. In some embodiments, there may be multiple sets of transformation parameters, one per each Virtual Function instantiated from the device for respective VMs, e.g., transformation parameters A for VF1 for VM1, and transformation parameters B for VF2 for VM2.

In some embodiments, the peripheral device returns timestamps of the PTM messages (transformed to the frame of reference of the VM) as well as the values communicated from the PTM Root (reception timestamp and propagation delay) to the VM. Software running on the VM may apply an equation from the PCIe specification to derive the values of two timestamps.

In other embodiments, the peripheral device returns a pair of simultaneous snapshots of the PTM Master Time (transformed to the frame of reference of the VM) and the peripheral device counter to the VM. Hardware or firmware of the peripheral device applies the equation from the PCIe specification.

The peripheral device may return any suitable timing data to the VM with the PTM Master Time data transformed to the frame of reference of the VM. The timing data may include any one or more of the following: interface between the Software and the peripheral device: a simultaneous/correlated snapshot of the peripheral device counter and the transformed PTM Master Time; a difference between the peripheral device counter and the transformed PTM Master Time; actual data from the PTM messages.

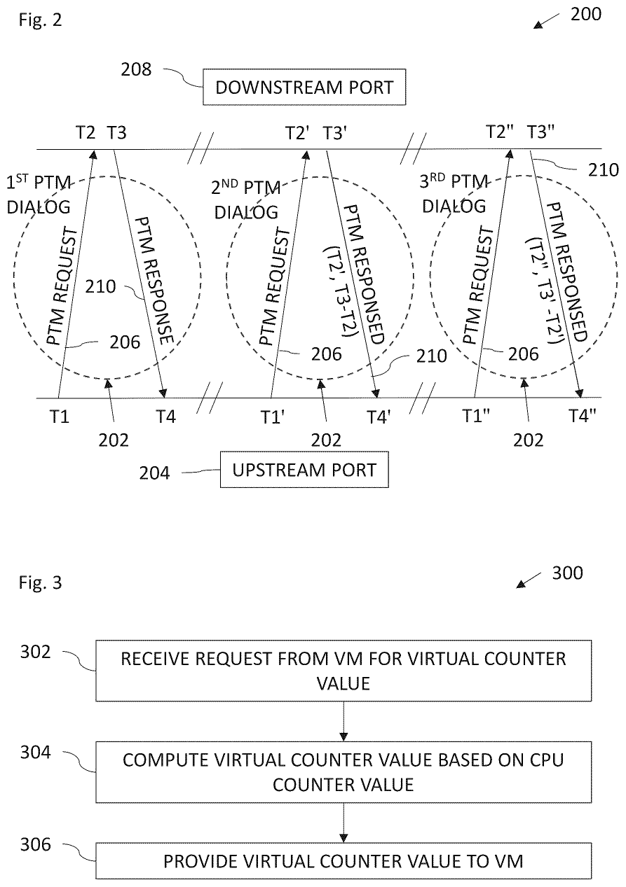

For example, the timing data may include the peripheral device time when the PTM Request was sent (T1′), PTM Master Time when the PTM Request was received (T2′) transformed to the frame of reference of the VM and the one-way delay across the PCIe interface measured by the peripheral device [(T4−T1)−(T3−T2)]/2 using nomenclature from PTM link protocol diagrams, described in more detail with reference to FIG. 2.

For example, the timing data may include the peripheral device time when the latest PTM Request was sent (T1′), the PTM Master Time when the latest PTM Request was received (T2′) transformed to the frame of reference of the VM and data necessary to calculate the one-way delay (i.e., the differences T4 minus T1 and T3 minus T2 using nomenclature from PTM link protocol diagrams, described in more detail with reference to FIG. 2).

For example, the timing data may include the peripheral device time when the latest PTM Request was sent (T1′), PTM Master Time when latest PTM Request was received (T2′) and data necessary to calculate the one-way delay (i.e., the T1, T2, T3 and T4 timestamps). Translation would be applied to T2′, T2 and T3.

### System Description

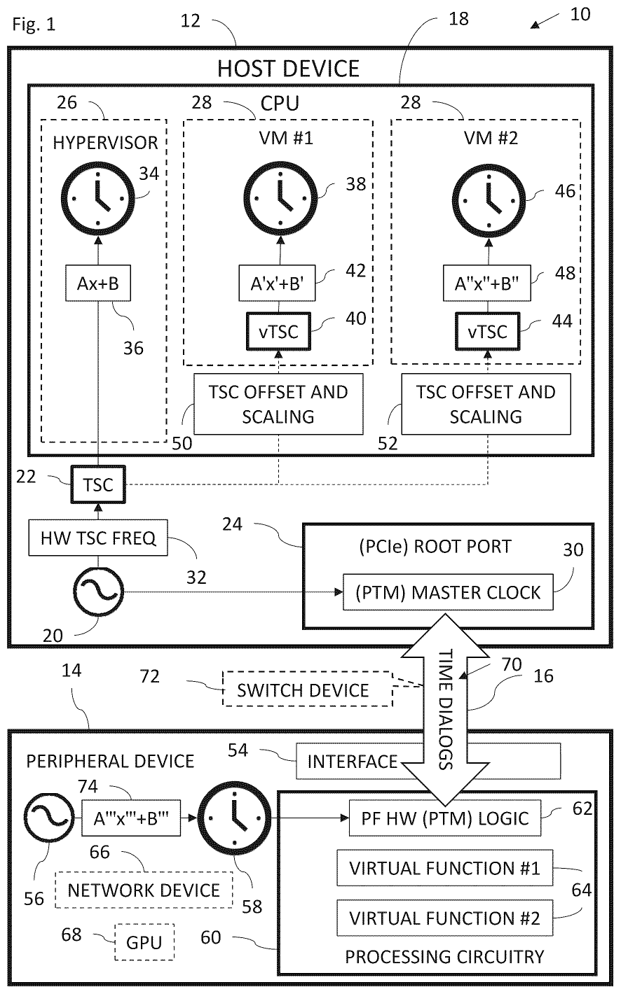

Reference is now made to FIG. 1, which is a block diagram view a clock measurement system 10 constructed and operative in accordance with an embodiment of the present disclosure. The clock measurement system 10 includes a host device 12 and a peripheral device 14 connected via a data communication bus 16.

The host device 12 includes a central processing unit (CPU) 18, an oscillator 20, a CPU counter 22 (e.g., a TSC), and a root port 24. The CPU 18 is configured to execute a hypervisor 26, and one or more virtual machines (VMs) 28 managed by the hypervisor 26. In the example of FIG. 1 the VMs 28 include two VMs, VM #1 and VM #2.

The host device 12 also includes a master clock 30 (e.g., a PTM master clock) to maintain a master clock time (e.g., a PTM master clock time). The master clock 30 may be comprised in the root port 24 (e.g., a PCIe root port).

The oscillator 20 is configured to provide an output signal for use by the master clock 30 and the CPU counter 22. In some embodiments, the master clock 30 and the CPU counter 22 may derive from different frequency sources. The master clock 30 and the CPU counter 22 may operate at different frequencies. For example, a hardware TSC frequency 32 feeds the CPU counter 22 and the hardware TSC frequency 32 may be a multiple, or a fraction, or the same, as the frequency of the oscillator 20. The value of the CPU counter 22 has a given relationship with the master clock time maintained by the master clock 30. The hypervisor 26 may maintain a clock 34 (e.g., with a time-of-day clock value) which is based on applying a transformation Ax+B (block 36) where x is the counter value of the CPU counter 22 and A and B are parameters. VM #1 may have a virtual time counter 40 (e.g., vTSC) based on an offset and scaling (block 50) from the CPU counter 22. VM #1 may maintain a clock 38 (e.g., with a time-of-day clock value) which is based on applying a transformation A′x′+B′ (block 42) where x′ is the counter value of the virtual time counter 40 and A′ and B′ are parameters. VM #2 may have a virtual time counter 44 (e.g., vTSC) based on an offset and scaling (block 52) from the CPU counter 22. VM #2 may maintain a clock 46 (e.g., with a time-of-day clock value) which is based on applying a transformation A″x″+B″ (block 48) where x″ is the counter value of the virtual time counter 44 and A″ and B″ are parameters.

The peripheral device 14 includes an interface 54, an oscillator 56, a hardware clock 58, and processing circuitry 60. The interface 54 is configured to transfer data between the root port 24 of the host device 12 via data communication bus 16. The hardware clock 58 is configured to maintain a peripheral device clock time. The oscillator 56 is configured to provide a clock signal to hardware clock 58. The hardware clock 58 may also include a counter (not shown) maintaining a counter value to which a transformation A′″x′″+B′″ (block 74) is applied to yield the peripheral device clock time.

The processing circuitry 60 may execute a physical function (PF) 62 to perform hardware logic, e.g., hardware PTM logic. The processing circuitry 60 may also execute virtual functions 64 of the VMs 28. The virtual functions 64 may include virtual function #1 for VM #1, and virtual function #2 for VM #2.

The processing circuitry 60 is configured to share time measurement messages with the host device 12 yielding time measurement dialogues 70 according to any suitable time measurement standard.

The peripheral device 14 may optionally include a network device 66 (e.g., a network interface controller (NIC) application-specific integrated circuit (ASIC). In some embodiments, one or more of the virtual functions 64 may be virtual network adapter(s) of the VM(s). The peripheral device 14 may optionally include a graphics processing unit (GPU) 68. In some embodiments, one or more of the virtual functions 64 may be a virtual GPU(s) of the VM(s).

In some embodiments, the clock measurement system 10 may include one or more switch devices 72 disposed in the communication data bus 16 between the host device 12 and the peripheral device 14. When there is one switch device 72 in the data communication bus 16, the peripheral device 14 exchanges time measurement messages with the (PCIe) switch 72 (not with the host device 12) and the (PCIe) switch 72 responds with Master Time information based on the measurement dialogs it exchanged with the host device 12. If there is more than one switch device 72, the PTM messages are exchanged between the direct link partners, i.e., the PTM messages are not forwarded across the (PCIe) switches 72.

In practice, some, or all of the functions of the processing circuitry 60 may be combined in a single physical component or, alternatively, implemented using multiple physical components. These physical components may comprise hard-wired or programmable devices, or a combination of the two. In some embodiments, at least some of the functions of the processing circuitry 60 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2, which is a data flow diagram 200 showing example time measurement dialogues 202 in the system 10 of FIG. 1. FIG. 2 shows three time-measurement dialogues 202 as labeled in FIG. 2. Each time measurement dialogue 202 includes an upstream port 204 (e.g., peripheral device 14) sending a PTM request 206 to a downstream port 208 (e.g., root port 24 of host device 12), and the downstream port 208 sending a PTM Response 210 (or ResponseD) to the upstream port 204. The various times, T1, T2, T3, T4, T1′ etc. shown in FIG. 2 provide the various transmit and receive times of the messages included in the time measurement dialogues 202.

The PTM Master Time at time T1′ may be equal to:

$$T {2}^{′} - \frac{( ( T 4 - T 1 ) - ( T 3 - T 2 ) )}{2}$$

Reference is now made to FIG. 3, which is a flowchart 300 including steps in a method performed by CPU 18 of host device 12 in the system 10 of FIG. 1. The CPU 18 is configured to receive a request from one of the VMs 28 (e.g., VM #1) for a virtual counter value of the virtual time counter 40 of VM #1 (block 302). The request may be inferred by the CPU 18 from an action performed by VM #1 such as VM #1 trying to read a memory address associated with the virtual time counter 40. The CPU 18 is configured to compute the virtual counter value of the virtual time counter 40 based on a given relationship (e.g., A′x′+B′) between the value of the CPU counter 22 and the virtual counter value (block 304). The CPU 18 is configured to provide the virtual counter value of VM #1 to VM #1 (block 306) upon request of VM #1 and based on the given relationship between the value of the CPU counter and the virtual counter value.

Reference is now made to FIG. 4, which is a flowchart 400 including steps in a method performed by a virtual machine in the system 10 of FIG. 1. The CPU 18, or the hypervisor 26 running on the CPU 18, is configured to instruct the peripheral device 14 to apply a transformation between the master clock time and the virtual counter value of the VM 28 requesting timing data when providing the master clock time to the requesting VM 28 (block 402). The transformation (for the requesting VM) between the master clock time and the virtual counter value of the requesting VM is based on (a) the given relationship between the value of the CPU counter 22 and the master clock time; and (b) the given relationship between the value of the CPU counter 22 and the virtual counter value of the requesting VM. Each VM typically has its own transformation. In some embodiments, the hypervisor 26 is configured to configure the virtual function(s) 64 (for VM #1 and/or VM #2) to apply the (respective) transformation between the master clock time and the virtual counter value of the requesting VM when providing the master clock time to that VM (block 404). Each VM may therefore have its own VF and its own transformation. The requesting VM is configured to send a request to the peripheral device 14 (e.g., to the VF of the requesting VM) for timing data derived from one or more time measurement dialogues (block 406). After processing by the peripheral device 14, or by the VF of the peripheral device 14, the VM is configured to receive the timing data from the peripheral device 14, or from the VF of the peripheral device 14, via the data communication bus 16 (block 408).

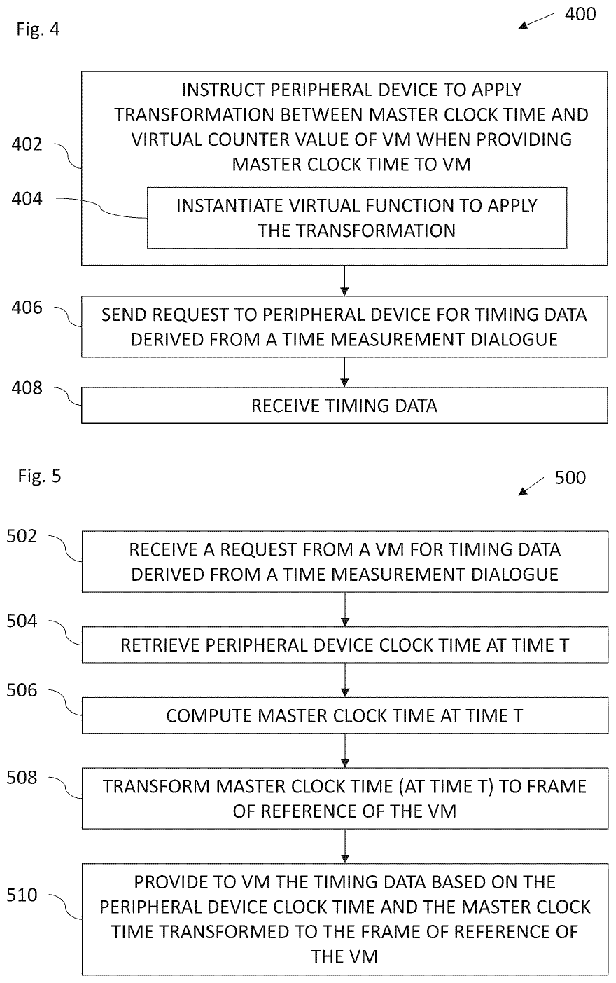

Reference is now made to FIG. 5, which is a flowchart 500 including steps in a method performed by the peripheral device 14 in the system 10 of FIG. 1.

The interface 54 is configured to receive from one of the VMs 28 running on host device 12, over data communication bus 16, a request for timing data derived from a time measurement dialogue (block 502). The timing data may be derived from the processing circuitry 60 being configured to retrieve the peripheral device clock time at time T (block 504) and compute the master clock time at time T (block 506). In some embodiments, the processing circuitry 60 is configured to compute the master clock time according to Precision Time Measurement (PTM) based on measurement messages exchanged by any two or more of the following: the host device 12; the peripheral device 14; and the switch device(s) 72 disposed in the communication data bus 16 between the host device 12 and the peripheral device 14.

The processing circuitry 60 is configured to transform the (computed) master clock time to a frame of reference of the requesting VM (block 508). In some embodiments, the processing circuitry 60 is configured to transform the master clock time to the frame of reference of the VM based on the transformation (for the requesting VM) between the master clock time and the virtual counter value of the requesting VM. In some embodiments, the processing circuitry 60 is configured to transform the master clock time at time t to the frame of reference of the requesting VM. In some embodiments, the processing circuitry 60 is configured to run the VF of the peripheral device 14 for the requesting VM to transform the master clock time to the frame of reference of the requesting VM based on the transformation between the master clock time and the virtual counter value of the requesting VM.

The (VF of the requesting VM running on the) processing circuitry 60 is configured to provide to the requesting VM, over the communication data bus 16, the timing data based on the peripheral device clock time, and the master clock time transformed to the frame of reference of the requesting VM (block 510). In some embodiments, the processing circuitry 60 is configured to provide to the requesting VM, over the communication data bus 16, the timing data including a simultaneous snapshot of the master clock time at time t transformed to the frame of reference of the requesting VM and the peripheral device clock time at time t. The timing may include any suitable timing data as described in more detail above in the overview section.

A simplified numerical example for the PTM Master Time translation in the peripheral device 14 now follows.

The following are definitions of terminology used in the example:

(a) PTM.MT is PTM Master Time as maintained in the PCIe Root Port and used in PCIe PTM dialogs. PTM.MT may be equal to the number of nanoseconds that have passed since boot of host device 12 when the value of PTM.MT counter is incremented once every nanosecond.

(b) vPTM.MT is the PTM Master Time translated to the VM's frame of reference according to this disclosure.

(c) DEVCNT is the peripheral device hardware (HW) counter and may be equal to the number of device cycles since device boot or number of nanoseconds since device boot or number of nanoseconds since Jan. 1, 1970, or some other format—but the actual format is irrelevant for this disclosure.

(d) TSC is the TimeStamp Counter or CPU HW counter and may be equal to the number of CPU cycles since boot.

(e) vTSC is the virtualized TSC made available to the Virtual Machine.

The example below provides arbitrary values for various coefficients and/or frequencies and other values.

Assuming TSC runs at 4 GHZ (i.e., every nanosecond, the value of TSC is increased by 4, or, conversely, the value of TSC is incremented 4 times per nanosecond), it follows that:

$$TSC\_RATE = 4 , and$$

$$TSC = PTM . MT * TSC\_RATE = PTM . MT * 4$$

PTM.MT is expressed in nanoseconds and both TSC and PTM.MT start at 0 on CPU boot.

On the other hand, assuming vTSC runs at 2 GHZ (i.e., if the Virtual Machine were to read the vTSC value in two successive nanoseconds, it would read a value of X and a value of X+2, respectively, or conversely speaking, the value of vTSC is incremented 2 times per nanosecond) and this is what the CPU provides to the VM, i.e., the CPU informs the VM that the vTSC frequency is 2 GHz, i.e., vTSC_RATE=2.

Additionally, assuming vTSC is then additionally offset by a constant value, e.g. 10000, vTSC_OFFSET=10000.

$$From this it follows that vTSC = ( vTSC\_RATE / TSC\_RATE ) * TSC + vTSC\_OFFSET ,$$

$$which is$$

$$= ( 2 / 4 ) * TSC + 10000 = 0.5 * TSC + 10000 , in our example .$$

For illustration purposes a bare-metal example is now provided.

If an application running on the bare metal (not in the Virtual Machine) would use PTM, it would obtain two values from the peripheral device (a simultaneous snapshot of PTM.MT and DEVCNT), namely, PTM.MT_0=500, and DEVCNT_0=450.

The bare metal would then calculate the corresponding TSC value and use it together with the device counter e.g. for purposes of synchronization, giving:

$$TSC\_ 0 = 4 * PTM . MT\_ 0 = 4 * 500 = 2000 , and$$

$$DEVCNT\_ 0 = 450.$$

Now, the same scenario is executed for the VM. The PTM dialogs still produce two values: PTM.MT_0=500, and DEVCNT_0=450.

The corresponding “HW”/bare-metal TSC value is still:

$$TSC\_ 0 = 4 * PTM . MT\_ 0 = 4 * 500 = 2000.$$

The corresponding virtualized vTSC value is however:

$$vTSC\_ 0 = 0.5 * TSC\_ 0 + 10000 = 0.5 * 2000 + 10000 = 1000 + 10000 = 11000.$$

The virtual machine “thinks” that the vTSC runs at 2 GHz and so when it gets the virtualized PTM Master Time value from the peripheral device, it will calculate vTSC as:

$$vTSC\_ 0 = 2 * vPTM . MT\_ 0$$

Therefore, the peripheral device must produce a virtualized PTM Master Time value such that when the Virtual Machine calculates the corresponding vTSC value, the VM will obtain the correct value.

The vPTM.MT_0 value that should be provided is therefore 5500.

That value (i.e., 5500) maybe produced based on:

$$vPTM . MT = PTM . MT + vTSC\_OFFSET / vTSC\_RATE \qquad ( equation 1 )$$

$$Therefore , vPTM . MT = PTM . MT + vTSC\_OFFSET / vTSC\_RATE = PTM . MT + 10000 / 2 = PTM . MT + 5000.$$

Therefore, the value that should be provided is:

$$vPTM . MT\_ 0 = PTM . MT\_ 0 + 5000 = 500 + 5000 = 5500$$

Equation may be obtained by solving the following equations:

On one hand vTSC=vTSC_RATE*vPTM.MT (equation 2), and on the other hand vTSC=TSC_SCALING*TSC+TSC_OFFSET (equation 3),

$$Where TSC\_SCALING = vTSC\_RATE / TSC\_RATE , \qquad ( equation 4 )$$

$$and$$

$$TSC = TSC\_RATE * PTM . MT .$$

Therefore, taking right sides of equations 2 and 3 gives:

$$vTSC\_RATE * vPTM . MT = TSC\_SCALING * TSC + TSC\_OFFSET$$

Substituting TSC_SCALING from equation 4 gives:

$$vTSC\_RATE * vPTM . MT = ( vTSC\_RATE / TSC\_RATE ) * TSC + TSC\_OFFSET$$

Substituting TSC gives:

$$vTSC\_RATE * vPTM . MT = ( vTSC\_RATE / TSC\_RATE ) * TSC\_RATE * PTM . MT + TSC\_OFFSET$$

Simplify the right-hand side of the equation (TSC_RATE cancels out) giving:

$$vTSC\_RATE * vPTM . MT = vTSC\_RATE * PTM . MT + TSC\_OFFSET .$$

Dividing both sides of the equation by vTSC_RATE provides vPTM.MT as a function of PTM.MT as follows:

$$vPTM . MT = PTM . MT + TSC\_OFFSET / vTSC\_RATE . \qquad ( equation 1 )$$

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising a peripheral device, which includes:
an interface to receive from a virtual machine (VM) running on a host device, over a communication data bus, a request for timing data derived from a time measurement dialogue, the host device maintaining a master clock time;
a hardware clock to maintain a peripheral device clock time; and
processing circuitry to:
transform the master clock time to a frame of reference of the VM; and
provide to the VM, over the communication data bus, the timing data based on the peripheral device clock time, and the master clock time transformed to the frame of reference of the VM.

2. The system according to claim 1, wherein the processing circuitry is to:
retrieve the peripheral device clock time at time t;
compute the master clock time at time t;
transform the master clock time at time t to the frame of reference of the VM; and
provide to the VM, over the communication data bus, the timing data including a simultaneous snapshot of the master clock time at time t transformed to the frame of reference of the VM and the peripheral device clock time at time t.

3. The system according to claim 1, wherein the processing circuitry is to transform the master clock time to the frame of reference of the VM based on a transformation between the master clock time and a virtual counter value of the VM.

4. The system according to claim 3, further comprising the host device including:
a master clock to maintain the master clock time;
a CPU counter, wherein a value of the CPU counter has a given relationship with the master clock time;
a central processing unit (CPU) to:
run a hypervisor to manage the VM;
provide the virtual counter value of the VM to the VM upon request of the VM based on a given relationship between the value of the CPU counter and the virtual counter value, wherein the transformation between the master clock time and the virtual counter value of the VM is based on (a) the given relationship between the value of the CPU counter and the master clock time; and (b) the given relationship between the value of the CPU counter and the virtual counter value.

5. The system according to claim 4, wherein the hypervisor is to instruct the peripheral device to apply the transformation between the master clock time and the virtual counter value of the VM when providing the master clock time to the VM.

6. The system according to claim 4, wherein the processing circuitry is to run a virtual function of the peripheral device to transform the master clock time to the frame of reference of the VM based on the transformation between the master clock time and the virtual counter value of the VM.

7. The system according to claim 6, wherein the hypervisor is to configure the virtual function to apply the transformation between the master clock time and the virtual counter value of the VM when providing the master clock time to the VM.

8. The system according to claim 6, wherein the peripheral device includes a network device, and the virtual function of the peripheral device is a virtual network adapter of the VM.

9. The system according to claim 4, wherein the host device includes a root port, which includes the master clock.

10. The system according to claim 9, wherein the host device includes an oscillator to provide an output signal for use by the master clock and the CPU counter.

11. The system according to claim 1, wherein the processing circuitry is to run a virtual function of the peripheral device to transform the master clock time to the frame of reference of the VM based on a transformation between the master clock time and a virtual counter value of the VM.

12. The system according to claim 11, wherein the peripheral device includes a network device, and the virtual function of the peripheral device is a virtual network adapter of the VM.

13. The system according to claim 11, wherein the peripheral device includes a graphic processing unit (GPU), and the virtual function of the peripheral device is a virtual GPU of the VM.

14. The system according to claim 1, wherein the master clock of the host device is comprised in a root port of the host.

15. The system according to claim 1, wherein the processing circuitry is to compute the master clock time according to Precision Time Measurement (PTM) based on measurement messages exchanged by any two or more of the following: the host device; the peripheral device; and a switch device disposed in the communication data bus between the host device and the peripheral device.

16. A method, comprising:
receiving from a virtual machine (VM) running on a host device, over a communication data bus, a request for timing data derived from a time measurement dialogue;
maintaining a peripheral device clock time;
transforming a master clock time to a frame of reference of the VM; and
providing to the VM, over the communication data bus, the timing data based on the peripheral device clock time, and the master clock time transformed to the frame of reference of the VM.

17. The method according to claim 16, further comprising: retrieving the peripheral device clock time at time t; and computing the master clock time at time t, wherein:
the transforming includes transforming the master clock time at time t to the frame of reference of the VM; and
the providing includes providing to the VM, over the communication data bus, the timing data including a simultaneous snapshot of the master clock time at time t transformed to the frame of reference of the VM and the peripheral device clock time at time t.

18. The method according to claim 16, wherein the transforming includes transforming the master clock time to the frame of reference of the VM based on a transformation between the master clock time and a virtual counter value of the VM.

19. The method according to claim 16, wherein the transforming includes transforming the master clock time to the frame of reference of the VM based on a transformation between the master clock time and a virtual counter value of the VM, the method further comprising providing the virtual counter value of the VM to the VM upon request of the VM based on a given relationship between the value of the CPU counter and the virtual counter value, wherein the transformation between the master clock time and the virtual counter value of the VM is based on (a) the given relationship between the value of a CPU counter and the master clock time; and (b) the given relationship between the value of the CPU counter and the virtual counter value.

20. The method according to claim 19, further comprising instructing the peripheral device by a hypervisor to apply the transformation between the master clock time and the virtual counter value of the VM when providing the master clock time to the VM.

21. The method according to claim 19, wherein the transforming is performed by a virtual function of a peripheral device.

22. The method according to claim 21, further comprising configuring the virtual function to apply the transformation.

23. The method according to claim 16, further comprising computing the master clock time according to Precision Time Measurement (PTM) based on measurement messages exchanged by any two or more of the following: the host device; a peripheral device; and a switch device disposed in the communication data bus between the host device and the peripheral device.
